(19) United States
(12) Patent Application Publication
(10) Pub. No.: US 2025/0068951 A1
(43) Pub. Date: Feb. 27, 2025

(54) CENTRALIZED LASER ANNEALING MANAGEMENT FOR MULTIPLE QUANTUM COMPUTING-BASED DEVICES

(71) Applicant: International Business Machines Corporation, Armonk, NY (US)

(72) Inventors: Eric Zhang, Sleepy Hollow, NY (US); Jared Barney Hertzberg, Yorktown Heights, NY (US); James B Hannon, Mahopac, NY (US); Russell A. Budd, North Salem, NY (US); Jeng-Bang Yau, Yorktown Heights, NY (US)

(21) Appl. No.: 18/452,966

(22) Filed: Aug. 21, 2023

(51) Int. Cl. G06N 10/40; G06N 10/80

(52) U.S. Cl. CPC G06N 10/40; G06N 10/80

(57) ABSTRACT

An apparatus comprises a memory configured to store program instructions and a processor operatively coupled to the memory to execute the program instructions to centrally manage a plurality of computer systems configured to respectively perform a laser annealing process on a plurality of quantum computing-based devices configured to function as a modular quantum device.

### BACKGROUND

This disclosure relates generally to techniques for tuning Josephson junction devices and, in particular, the laser annealing techniques for tuning the tunnel junction resistances of Josephson junction devices. A quantum computing system can be implemented using superconducting circuit quantum electrodynamics (cQED) architectures that are constructed using quantum circuit components such as, e.g., superconducting quantum bits (e.g., fixed-frequency transmon quantum bits), superconducting quantum interference devices (SQUIDs), and other types of superconducting devices which comprise Josephson junction devices. In particular, superconducting quantum bits (qubits) are electronic circuits which are implemented using components such as superconducting tunnel junctions (e.g., Josephson junctions), inductors, and/or capacitors, etc., and which behave as quantum mechanical anharmonic (non-linear) oscillators with quantized states, when cooled to cryogenic temperatures. A fixed-frequency qubit, such as a transmon qubit, has a transition frequency (denoted f₀₁) that corresponds to an energy difference between a ground state |0 [symbol] and a first excited state |1 [symbol] of the qubit. It is known that the transition frequency f₀₁ of a qubit can be estimated from the tunnel junction resistance (denoted R_{J}) of the Josephson junction of the qubit.

A solid-state quantum processor can include multiple superconducting qubits that are arranged in a given lattice structure (e.g., square lattice, heavy hexagonal lattice) to enable quantum information processing through quantum gate operations (e.g., single-qubit gate operations and multi-qubit gate operations) in which quantum information is generated and encoded in computational basis states (e.g., |0 [symbol] and |1 [symbol] ) of single qubits, superpositions of the computational basis states of single qubits, and/or entangled states of multiple qubits. Continuing technological advances in quantum processor design are enabling the rapid scaling of both the physical number of superconducting qubits and the computational capabilities of quantum processors. Indeed, while current state-of-the art quantum processors have greater than 50 qubits, it is anticipated that future quantum processors will have a much larger number of qubits, e.g., on the order of hundreds or thousands of qubits, or more.

Scaling the number of qubits (e.g., fixed-frequency transmon qubits) in a qubit lattice, while maintaining high-fidelity quantum gate operations, remains a key challenge for quantum computing. For example, as superconducting quantum processors scale to larger numbers of qubits, frequency crowding within a qubit lattice becomes increasingly problematic since the transition frequencies of the qubits need to be precisely controlled to minimize gate errors that can arise from lattice frequency collisions (e.g., improper detuning between superconducting qubits can reduce the fidelity of multi-qubit gate entanglement operations). Due to processing variabilities, however, the transition frequencies of superconducting qubits as fabricated can deviate from design targets.

In this regard, laser annealing techniques can be used to adjust qubit frequencies post-fabrication and thereby selectively tune fixed-frequency qubits of a given qubit lattice into desired frequency patterns. In particular, laser annealing techniques can be utilized to increase collision-free yield of fixed-frequency qubit lattices by selectively trimming (i.e., tuning) individual qubit frequencies post-fabrication by enabling localized thermal annealing of the Josephson junctions of the qubits to thereby adjust and stabilize the tunnel junction resistance R_{J} of the respective Josephson junctions (and correspondingly, the respective qubit transition frequencies f₀₁) with high precision. The tuning of qubit transition frequencies through laser annealing, however, is non-trivial due to, e.g., inherent variabilities of the laser anneal process itself and/or the equipment that is utilized to perform such laser annealing, post fabrication, to tune the qubit transition frequencies in a given qubit lattice. Although fixed-frequency qubits are herein described as a typical candidate for laser tuning, it may be understood that the process of laser tuning applies to any quantum element comprising at least one Josephson junction, including, but not limited to fixed-frequency transmon qubits, SQUID devices, and the like.

Furthermore, in order to increase quantum computational capacity and capabilities (for example, to realize quantum advantage, whereby distinct computational benefit is realized by the use of quantum computation as compared to classical computation), an increasingly greater number of qubits must be used to access a greater quantum computational space. A quantum processor may be a singulated die, or chip, that comprises a number of functional qubits, quantum logic structures, and quantum coupling structures. However, practical constraints on the physical dimensions of a singulated chip limit the number of qubits that may be fabricated and therefore used for quantum computation.

### SUMMARY

Illustrative embodiments include techniques for implementing centralized laser annealing management functionalities in a computer system architecture.

For example, in an illustrative embodiment, an apparatus comprises a memory configured to store program instructions, and a processor operatively coupled to the memory to execute the program instructions to centrally manage a plurality of computer systems configured to respectively perform a laser annealing process on a plurality of quantum computing-based devices configured to function as a modular quantum device.

In another illustrative embodiment, a method comprises centrally managing a plurality of computer systems configured to respectively perform a laser annealing process on a plurality of quantum computing-based devices configured to function as a modular quantum device.

In another illustrative embodiment, a computer program product for performing laser annealing comprises one or more computer readable storage media, and program instructions collectively stored on the one or more computer readable storage media, the program instructions comprising program instructions to centrally manage a plurality of computer systems configured to respectively perform a laser annealing process on a plurality of quantum computing-based devices configured to function as a modular quantum device.

In another illustrative embodiment, a computer system architecture comprises a plurality of first computer systems. The plurality of first computer systems is configured to respectively perform a laser annealing process on a plurality of quantum computing-based devices configured to function as a modular quantum device. The computer system architecture further comprises a second computer system operatively coupled to the plurality of first computer systems. The second computer system is configured to centrally manage the laser annealing process respectively performed by the plurality of first computer systems on the plurality of quantum computing-based devices configured to function as the modular quantum device.

In another illustrative embodiment, as may be combined with the preceding paragraphs, centrally managing the plurality of computer systems may further comprise generating a tuning plan for the modular quantum device.

In another illustrative embodiment, as may be combined with the preceding paragraphs, the tuning plan for the modular quantum device may be based on at least one of: one or more modularity parameters, one or more modularity constraints, and one or more screening criteria.

In another illustrative embodiment, as may be combined with the preceding paragraphs, centrally managing the plurality of computer systems may further comprise sending data to the plurality of computer systems to enable the portion of the plurality of computer systems to respectively perform the laser annealing process on the corresponding plurality of quantum computing-based devices configured to function as a modular quantum device.

In another illustrative embodiment, as may be combined with the preceding paragraphs, sending the data to the plurality of computer systems may be performed in a synchronized manner to enable coordinated performance of the laser annealing process across the portion of the plurality of computer systems.

In another illustrative embodiment, as may be combined with the preceding paragraphs, the data sent to each of the plurality of computer systems may comprise program code and parameters configured to control the laser annealing process performed by each of the portion of the plurality of computer systems.

In another illustrative embodiment, as may be combined with the preceding paragraphs, centrally managing the plurality of computer systems may further comprise receiving data associated with the plurality of computer systems following respective performance of at least one iteration of the laser annealing process on the corresponding plurality of quantum computing-based devices.

In another illustrative embodiment, as may be combined with the preceding paragraphs, the data associated with the plurality of computer systems following respective performance of at least one iteration of the laser annealing process may be received from a database that is at least one of local to the apparatus and remote from the apparatus.

In another illustrative embodiment, as may be combined with the preceding paragraphs, centrally managing the plurality of computer systems may further comprise analyzing at least a portion of the received data and adjusting a subsequent performance of the laser annealing process at one or more of the plurality of computer systems based on the analyzing of the portion of the received data.

In another illustrative embodiment, as may be combined with the preceding paragraphs, analyzing at least a portion of the received data may further comprise performing a yield analysis to assess yield results of a previous performance of the laser annealing process at the portion of the plurality of computer systems.

In another illustrative embodiment, as may be combined with the preceding paragraphs, adjusting a subsequent performance of the laser annealing process at one or more of the plurality of computer systems may further comprise modifying one or more aspects of the laser annealing process for one or more of the plurality of computer systems.

In another illustrative embodiment, as may be combined with the preceding paragraphs, modifying the one or more aspects of the laser annealing process may further comprise changing one or more of a yield target value, a frequency configuration, and the one or more quantum computing-based devices corresponding to the one or more of the plurality of computer systems.

In another illustrative embodiment, as may be combined with the preceding paragraphs, a second computer system centrally manages a plurality of first computer systems, and a control module to coordinate the plurality of first computer systems and anneal processes may be implemented at least one of local to the second computer system and remote from the second computer system.

In another illustrative embodiment, as may be combined with the preceding paragraphs, a control module may be implemented to coordinate a plurality of computer systems to select, coordinate laser annealing processes, and monitor yield of devices corresponding to the one or more of the plurality of computer systems, which may be part of a larger interconnected and modular quantum device.

In another illustrative embodiment, as may be combined with the preceding paragraphs, a control module may be used to select a stock of individual quantum devices corresponding to the one or more of the plurality of computer systems, to create a stock of usable quantum computing-based devices that may be part of a larger interconnected and modular device.

In another illustrative embodiment, as may be combined with the preceding paragraphs, a control module may be used to select a stock of individual quantum devices corresponding to the one or more of the plurality of computer systems, that satisfy a yield target value.

In another illustrative embodiment, as may be combined with the preceding paragraphs, the plurality of screened devices may be selected on a second computer system that centrally manages the plurality of computer systems and laser annealing process, using yield target and quantum device parameters as they relate to a larger interconnected and modular quantum device.

In another illustrative embodiment, as may be combined with the preceding paragraphs, a control module may coordinate the screening and tuning of a modular quantum device using feedback from a plurality of computer systems to ensure satisfactory annealing performance.

In another illustrative embodiment, as may be combined with the preceding paragraphs, a control module may use feedback from a plurality of computer systems to reject individual quantum devices that may or may not be part of a larger interconnected modular quantum device.

In another illustrative embodiment, as may be combined with the preceding paragraphs, a control module may use feedback from a plurality of computer systems to modify frequency plans or the interconnectivity arrangement of individual quantum devices that may or may not be part of a larger interconnected modular quantum device.

In another illustrative embodiment, as may be combined with the preceding paragraphs, centrally managing the plurality of computer systems may further comprise causing calibration of the plurality of computer systems prior to respective performance of the laser annealing process on the plurality of quantum computing-based devices.

In another illustrative embodiment, as may be combined with the preceding paragraphs, centrally managing the plurality of computer systems may further comprise receiving calibration data from the plurality of computer systems following calibration.

In another illustrative embodiment, as may be combined with the preceding paragraphs, centrally managing the plurality of computer systems may further comprise tracking in a database one or more qubit junctions in each of the plurality of quantum computing-based devices with respect to a chip identifier, a wafer identifier, and a laser annealing process identifier.

In another illustrative embodiment, as may be combined with the preceding paragraphs, the laser annealing process may comprise a process for laser annealing of stochastically impaired qubits (LASIQ).

In another illustrative embodiment, as may be combined with the preceding paragraphs, the laser annealing process may be used to laser anneal any quantum element comprising one or more Josephson junctions, to allow inter-device coupling of functional qubits, quantum-logic structures, or quantum coupling structures as may occur on a larger interconnected modular quantum device.

Advantageously, illustrative embodiments may comprise a computer system that is configured to provide centralized laser annealing management functionalities which may include pushing data to and pulling data from multiple laser annealing tool computers, organizing data into a hierarchical and dynamic database, and performing yield prediction analysis and candidate selection, so as to synchronize or otherwise coordinate tuning of multiple quantum computing-based devices.

Further advantageously, illustrative embodiments overcome constraints on the physical dimensions of a singulated chip which limits the number of qubits that may be fabricated and therefore used for quantum computation. More particularly, illustrative embodiments provide for interconnecting a number of quantum devices on an interconnection manifold, thereby forming a modular quantum device which allows a plurality of individual quantum devices to communicate amongst each other and behave as an effectively larger device. In this sense, a modular quantum device is intended to increase the quantum computational capacity beyond any of its individual constituent quantum devices. Similar to aforementioned challenges of frequency crowding on single quantum devices, modular quantum devices must also minimize frequency collisions, both within each individual quantum device, as well as across adjacently connected devices. Laser annealing techniques according to illustrative embodiments may therefore be used to increase the yield of collision-free lattices, which would now extend across multiple devices on a modular interconnection manifold.

Other embodiments will be described in the following detailed description of illustrative embodiments, which is to be read in conjunction with the accompanying figures.

### BRIEF DESCRIPTION OF THE DRAWINGS

FIG. 1 illustrates a computer system architecture with centralized laser annealing management functionalities according to an illustrative embodiment.

FIG. 2 illustrates a computer system architecture with centralized laser annealing management functionalities according to another illustrative embodiment.

FIG. 3 illustrates a linear process flow for centralized laser annealing management according to an illustrative embodiment.

FIG. 4 illustrates a non-linear process flow for centralized laser annealing management according to an illustrative embodiment.

FIG. 5 illustrates a calibration process flow in a computer system architecture with centralized laser annealing management functionalities according to an illustrative embodiment.

FIGS. 6A through 6D illustrate a tuning process flow in a computer system architecture with centralized laser annealing management functionalities according to an illustrative embodiment.

FIG. 7 illustrates an exemplary tuning data sequence associated with a tuning process flow in a computer system architecture with centralized laser annealing management functionalities according to an illustrative embodiment.

FIG. 8 illustrates an exemplary database process flow associated with a computer system configured with centralized laser annealing management functionalities according to an illustrative embodiment.

FIG. 9 illustrates a process flow for determining completion of a tuning process in a computer system architecture with centralized laser annealing management functionalities according to an illustrative embodiment.

FIG. 10 illustrates a methodology for centralized laser annealing management according to an illustrative embodiment.

FIG. 11 illustrates an exemplary architecture of a computing environment with centralized laser annealing management functionalities according to an illustrative embodiment.

### DETAILED DESCRIPTION

Illustrative embodiments will now be described in further detail with regard to centralized laser annealing management for multiple quantum computing-based devices. In one non-limiting example, laser annealing may comprise a process for laser annealing of stochastically impaired qubits (LASIQ). However, while some illustrative embodiments refer to the term LASIQ, it is to be understood that embodiments are not intended to be limited to any particular laser annealing processes. It may be understood that the apparatus, computer system architectures, computer program products, and methods embodied herein apply to any process by which elements on a single or plurality of quantum processors containing Josephson junctions are tuned (of which a specific example is LASIQ), thereby tuning the corresponding frequency of those elements.

It is to be appreciated that the term “quantum computing-based device” as used herein is meant to broadly refer to any device, such as an integrated circuit device or chip, which comprises qubits and possibly other quantum components. For example, a quantum computing-based device can be a semiconductor die which comprises an array (lattice) of qubits, which is fabricated on a wafer comprising multiple dies, and which can be diced (cut) from the wafer using a die singulation process to provide a singulated die. In some embodiments, a quantum computing-based device can be a wafer with multiple semiconductor die. In the context of quantum computing, a quantum computing-based device may comprise one or more processors for a quantum computer.

The term “modular device” or “modular quantum device” as used herein is meant to broadly refer to a device that may comprise multiple interconnected quantum computing-based devices, e.g., multiple quantum processors for a quantum computer. A modular quantum device may be constructed from a plurality of individual quantum computing-based devices, or processors, each of which is a singulated die or chip. These individual quantum processors may be situated or housed within a modular interconnection manifold, which may contain microwave lines, resonators, couplers and the like to mediate the interaction and transfer of quantum information and states across individual chip boundaries. The modular quantum device is intended to have a quantum computational capacity that exceeds each individual quantum device within the manifold. Similar to challenges posed by quantum devices or processors based on singulated dies, modular devices will also suffer frequency crowding, and additionally, it is not sufficient to merely mitigate collisions within each singulated die, but also mitigate collisions across the boundary of adjacent chips to ensure the modular device as a whole is not negatively impacted by frequency collisions between chips. As described above, LASIQ tuning, or any tuning process by which elements comprising one or more Josephson junctions are tuned, may be implemented with an appropriate tuning plan on a modular device to mitigate frequency crowding and improve computational performance.

It is to be further appreciated that the terms “centrally manage,” “central management,” “centralized management,” and the like, broadly refer to one computer system (e.g., computing device, platform, tool, etc.) collectively managing two or more other computer systems (e.g., computing devices, platforms, tools, etc.). While the computer system that provides the central management may, in some embodiments, be remote (e.g., geographically and/or functionally) from the computer systems which it manages, it is not a necessity in other embodiments. For example, in some embodiments, the computer system that provides central management may be co-located with one or more of the computer systems which it manages. Further, in some embodiments, central management functionalities described herein may be implemented on one or more of the computer systems which are being centrally managed. Still further, in some embodiments, centrally managing two or more computer systems may comprise linear management, non-linear management, combinations thereof, or other types of management, sequential in nature or otherwise. Such management may, for example, be implemented in the tuning of multiple quantum devices that may eventually be part of the same modular quantum device. In this context, a central management scheme may therefore be used to coordinate the tuning of a modular device using a plurality of computer systems, each of which control a frequency tuning apparatus.

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the terms “illustrative” and “exemplary” as used herein mean “serving as an example, instance, or illustration.” Any embodiment or design described herein as “illustrative” “exemplary” or “some” is not to be necessarily to be construed as preferred or advantageous over other embodiments or designs.

Further, it is to be understood that the phrase “configured to” as used in conjunction with a system, network, apparatus, device, platform, tool, circuit, structure, element, component, or the like, performing one or more functions or otherwise providing some functionality, is intended to encompass embodiments wherein the system, network, apparatus, device, platform, tool, circuit, structure, element, component, or the like, is implemented in hardware, software, and/or combinations thereof. In some non-limiting examples, implementations may comprise hardware such as, but not limited to, quantum circuit elements (e.g., quantum processors, quantum bits, Josephson junction devices, Josephson parametric converters, quantum-limited amplifiers (QLAs), qubit coupler circuitry, etc.), discrete circuit elements (e.g., transistors, inverters, etc.), programmable elements (e.g., application specific integrated circuit (ASIC) chips, field-programmable gate array (FPGA) chips, etc.), processing devices (e.g., central processing units (CPUs), graphics processing units (GPUs), etc.), storage devices, network devices, one or more integrated circuits, and/or combinations thereof. Thus, by way of example only, when a system, network, apparatus, device, platform, tool, circuit, structure, element, component, etc., is defined to be configured to provide a specific functionality, it is intended to cover, but not be limited to, embodiments where the system, network, apparatus, device, platform, tool, circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the system, network, apparatus, device, platform, tool, circuit, structure, element, component, etc., is in a non-operational state (e.g., not connected nor otherwise deployed in a system, not powered on, not receiving an input, and/or not producing an output) or in a partial operational state.

It is realized herein that in a scenario where multiple LASIQ tools (i.e., computer systems configured to respectively perform laser annealing techniques) need to tune multiple quantum computing-based devices for a single quantum processor (e.g., modular devices) or multiple quantum processors (e.g., non-modular devices), there is a need to coordinate code and data depending on the devices being tuned. In some scenarios, the data in each LASIQ tool may not be independent and needs to be synchronized and aggregated. Further, multiple systems may have slightly different hardware and automation needs and will need customized codebases and version control. The term “codebase” illustratively refers to program code that is used to drive or otherwise control the LASIQ tool, e.g., downloaded and executed by a LASIQ tool. Still further, in other scenarios, tuning of modular devices may dictate that multiple devices not be tuned on the same system, but collisions still be mitigated between the modular devices. As such, data needs to be synchronized in real-time. The aggregated and synchronized data should facilitate querying, and be stored in an easily accessible format that is linked to useful chip parameters (e.g., lot, wafer, evaporation, qubit frequencies, etc.). Existing laser annealing systems do not provide the above functionalities and/or advantages.

Illustrative embodiments overcome the above and other technical drawbacks associated with existing systems by providing a central LASIQ computer system that is configured to securely push code and pull data, organize the data into a hierarchical and dynamic database, and perform yield prediction analysis and candidate selection. Further, in some illustrative embodiments, a central LASIQ computer system is accessible by a user to pull the data or synchronize code with an online repository or some other source. In some illustrative embodiments, a central LASIQ computer system is responsible for computationally intensive tasks, yield predictions, pre-and post-screening metrics, and compatibility of individual chips for a large modular device, as will be explained in further detail herein.

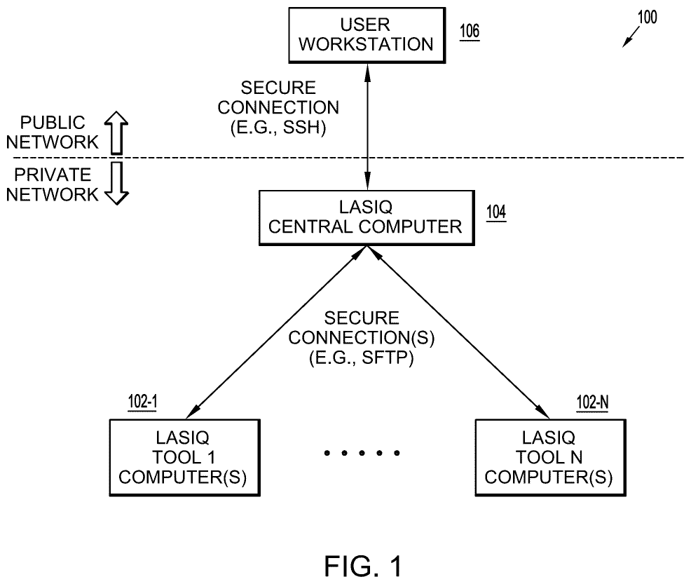

FIG. 1 illustrates a high-level computer system architecture 100 with centralized laser annealing management functionalities according to an illustrative embodiment. More particularly, as shown, computer system architecture 100 comprises a plurality of LASIQ tool computers 102-1 through 102-N (i.e., LASIQ tool 1 computer(s), . . . LASIQ tool N computer(s)) operatively coupled to a LASIQ central computer 104. A user workstation 106 is operatively coupled to the LASIQ central computer 104.

In some illustrative embodiments, each of the plurality of LASIQ tool computers 102-1 through 102-N (referred to herein collectively as LASIQ tool computers 102 or individually as LASIQ tool computer 102) may comprise one or more computer systems. For example, as explained above, laser annealing techniques (e.g., LASIQ) can be used to adjust qubit frequencies post-fabrication in quantum circuit components such as, e.g., superconducting quantum bits (e.g., fixed-frequency transmon quantum bits), superconducting quantum interference devices (SQUIDs), and other types of superconducting devices which comprise Josephson junction devices. Thus, for a quantum computing-based device with multiple qubits (e.g., a multi-qubit chip), laser annealing techniques are used to selectively tune qubits of a given lattice geometry into desired frequency patterns. Similar methods may be applied to a series of interconnected quantum processors, as in the case of modular quantum devices. In this case, laser annealing may be used to tune each individual chip, while also ensuring that the boundary of each adjacent interconnected chip is free of collisions. In particular, laser annealing techniques can be utilized to increase collision-free yield of fixed-frequency qubit lattices by selectively trimming (i.e., tuning) individual qubit frequencies post-fabrication by enabling localized annealing of the Josephson junctions of the qubits to thereby adjust and stabilize the tunnel junction resistance R_{J} of the respective Josephson junctions (and correspondingly, the respective qubit transition frequencies f₀₁) with high precision.

As such, in some illustrative embodiments, each LASIQ tool computer 102 may comprise a computer system for performing the laser annealing process and another computer integrated in a feedback arrangement with the laser annealing computer, for measuring the laser annealing results so that optimal or otherwise preferred tuning results can be achieved through iterative laser annealing stages, steps, or the like. By way of example only, the computer system for measuring the laser annealing results may comprise an electrical characterization system to obtain in-situ resistance measurements as well as a prober system for controlling movement, alignment, and temperature control of the multi-qubit chip being laser annealed.

The prober system may be configured to automatically move the position of a quantum computing-based device during a laser annealing process to align a target Josephson junction of a given qubit within the field of view (FOV) of a microscope unit to perform an in-situ Josephson junction resistance measurement and a laser anneal of the target Josephson junction. In particular, the quantum computing-based device may be mounted to an automated X-Y-Z stage which is controllably moved in three dimensions to align features of the quantum computing-based device within the FOV of the microscope unit and enable contact between electrical probes and contact pads on the quantum computing-based device. For example, in some embodiments, during a laser anneal process, a target Josephson junction of a given qubit is aligned to the center of the FOV of the microscope unit using an automated pattern recognition process in which features of an image captured by a camera are automatically aligned to corresponding features of a template image to ensure proper positioning of the target Josephson junction and associated contact pads. In particular, an alignment process is performed to ensure accurate registration between the contact pads of the target Josephson junction and the electrical probes when performing an in-situ Josephson junction resistance measurement. In addition, an alignment process is performed to ensure a proper alignment of the target Josephson junction and a laser spot pattern when performing a laser anneal operation.

As noted above, the electrical probes are implemented to perform in-situ Josephson junction resistance measurements during a laser anneal process. In particular, in-situ Josephson junction resistance measurements are performed in between laser annealing operations (shots) to track the tuning progress of the Josephson junctions of the qubits during a multi-step anneal process in which the Josephson junctions are progressively tuned. In some embodiments, the electrical probes comprise two pairs of probes, which are configured to perform a 4-wire resistance measurement (or Kelvin resistance measurement) to, more precisely, measure the junction resistance of a Josephson junction. In general, a 4-wire (Kelvin) resistance measurement involves determining the resistance of a given Josephson junction by measuring a current (I) flow through the junction as well as a voltage (V) drop across the junction, and determining the junction resistance R from Ohm's Law, i.e., R=V/I. In some alternative embodiments, the junction resistance is determined using a 4-wire (Kelvin) probe resistance measurement operation, whereby a constant voltage is sourced across the Josephson junction, and the resulting current is measured, and the junction resistance is determined based on the magnitude of the constant voltage and the measured current.

It is to be appreciated that any laser equipment, optical system, and prober system used to perform the laser annealing operations on a given quantum computing-based device are under local control of the corresponding LASIQ tool computer 102, once programmed by LASIQ central computer 104.

However, it is to be understood that embodiments are not intended to be limited to any particular computer architecture for each LASIQ tool computer 102. Also, in some embodiments, it is to be understood that one or more LASIQ tool computers 102 can have different laser annealing configurations and/or functionalities than one or more other LASIQ tool computers 102.

As further shown in FIG. 1, LASIQ tool computers 102 are operatively coupled to LASIQ central computer 104 via one or more secure connections. By way of example only, the one or more secure connections can be implemented via a secure communications protocol such as a Secure File Transfer Protocol (SFTP) or the like. LASIQ central computer 104, as will be further explained in detail herein, provides centralized laser annealing management functionalities according to one or more illustrative embodiments. For example, LASIQ central computer 104 is configured to coordinate which codebase version to send (e.g., push) to each LASIQ tool computer 102, and to obtain (e.g., pull) measurement data and other metrics from each LASIQ tool computer 102, and synchronize the laser annealing operations across LASIQ tool computers 102. Advantageously, LASIQ central computer 104 is able to coordinate access to LASIQ tool computers 102 so that real-time synchronized tuning can be performed.

Still further as shown in FIG. 1, user workstation 106 is operatively coupled to LASIQ central computer 104 via a secure connection. In some illustrative embodiments, user workstation 106 may be in a public network, while LASIQ tool computers 102 and LASIQ central computer 104 are in a private network. As such, the secure connection between user workstation 106 and LASIQ central computer 104 can be implemented via a secure communications protocol such as a Secure Socket Shell (SSH) or the like. SSH is a network protocol that gives users a secure way to access a computer residing in a private network over an unsecured public network.

In some illustrative embodiments, user workstation 106 enables a system administrator to query LASIQ central computer 104 or otherwise provide instructions, data, and/or program code to LASIQ central computer 104 so as to enable automated and/or semi-automated centralized management of the laser annealing operations performed by LASIQ tool computers 102.

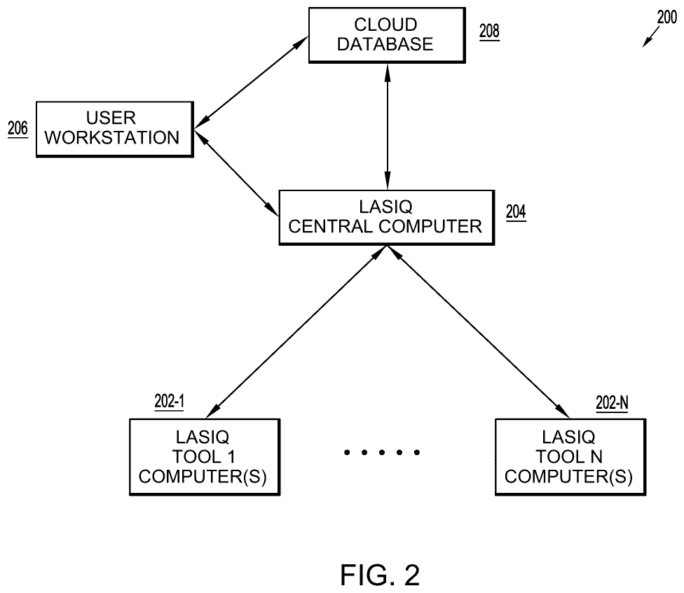

Other computer system architectures with centralized laser annealing management functionalities are contemplated in alternative embodiments. For example, FIG. 2 illustrates a high-level computer system architecture 200 with centralized laser annealing management functionalities according to another illustrative embodiment. More particularly, as shown, computer system architecture 200 comprises a plurality of LASIQ tool computers 202-1 through 202-N (i.e., LASIQ tool 1 computer(s), . . . LASIQ tool N computer(s)) operatively coupled to a LASIQ central computer 204. A user workstation 206 is operatively coupled to the LASIQ central computer 204. It is to be appreciated that, in some illustrative embodiments, LASIQ tool computers 202-1 through 202-N (referred to herein collectively as LASIQ tool computers 202 or individually as LASIQ tool computer 202), LASIQ central computer 204, and user workstation 206 are respectively configured with the same or similar functionalities as described herein with respect to LASIQ tool computers 102-1 through 102-N, LASIQ central computer 104, and user workstation 106.

However, computer system architecture 200 further comprises a cloud database 208 operatively coupled to LASIQ central computer 204 and user workstation 206. Cloud database 208 is configured to, inter alia, store data used by LASIQ central computer 204 to manage laser annealing operations performed by LASIQ tool computers 202. By way of example only, cloud database 208 can store codebase versions and tuning parameters to send (e.g., push) LASIQ tool computers 202 and measurement data and other metrics obtained (e.g., pulled) from LASIQ tool computers 202. LASIQ central computer 204 can synchronize the laser annealing operations across LASIQ tool computers 202. In some embodiments, cloud database 208 can be implemented as a public cloud, a private cloud, or a combination thereof. In some embodiments, cloud database 208 can be co-located with LASIQ central computer 204.

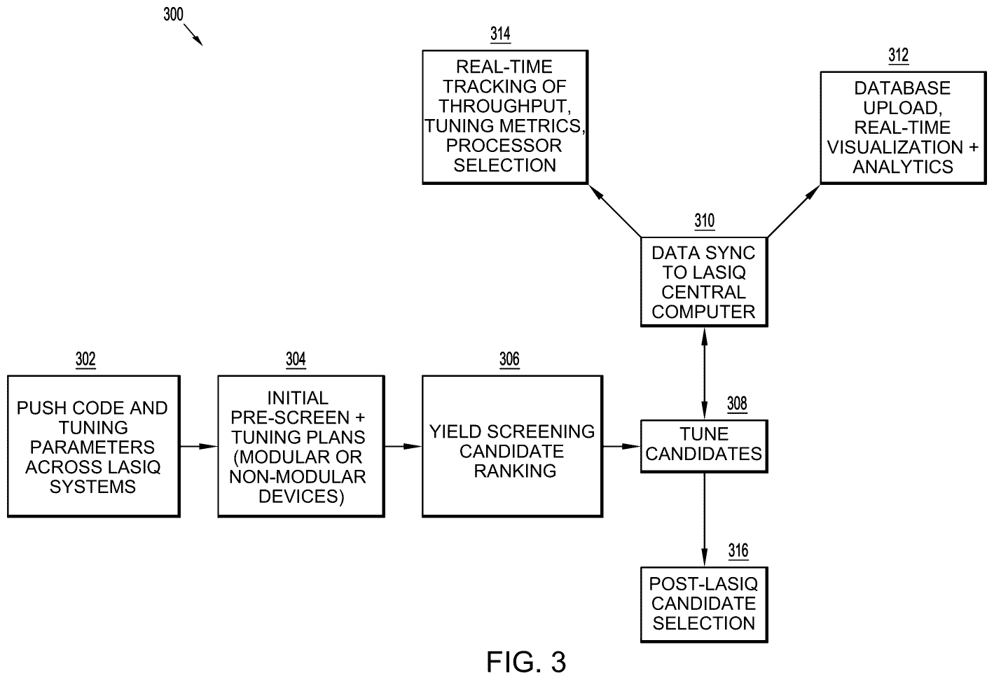

FIG. 3 illustrates a linear process flow 300 for centralized laser annealing management according to an illustrative embodiment. It is to be appreciated that linear process flow 300 is one non-limiting example of a computer system (e.g., LASIQ central computer 104 or 204) centrally managing laser annealing functionalities associated with a plurality of LASIQ tool computers (LASIQ tool computers 102 or 202).

As shown, in step 302, a LASIQ central computer pushes code (e.g., codebase) and tuning parameters (as will be further explained below) across multiple LASIQ tool computers. In step 304, the LASIQ central computer performs an initial yield pre-screening of the multiple LASIQ tool computers and generation of respective tuning plans for the quantum computing-based devices (e.g., modular and non-modular devices) being laser annealed. In some embodiments, a non-modular device may be understood to indicate a quantum processor which is obtained by a singulated die that is its own entity and is not in communication with any other quantum processor for the purpose of enhancing computational capacity. Conversely, in some alternative embodiments, a modular device may be understood to refer to a collection of interconnected quantum processors, which may be locally or non-locally connected through functional quantum coupling structures with the purpose of expanding the computational capability beyond any single element of the modular device. For example, a modular device may be one whereby a collection of interconnected quantum processors are coupled on a manifold consisting of some combination of fixed microwave links, tunable couplers, or the like.

By the term “yield,” recall that a goal of manufacturing a quantum computing-based device (e.g., quantum processor) is to increase the collision-free yield of qubit lattices by selectively trimming (i.e., tuning) individual qubit frequencies post-fabrication by enabling localized annealing of the Josephson junctions of the qubits to thereby adjust and stabilize the tunnel junction resistance R_{J} of the respective Josephson junctions (and correspondingly, the respective qubit transition frequencies f₀₁). Such yield may be determined by performing statistical analysis to determine the expected number of collisions that will be obtained both within and across each chip of a modular device. Equivalently, it is possible to calculate the expected probability of a zero-collision chip or modular device. This may be accomplished, for example, using a Monte Carlo method, or the like, by which the predicted frequencies undergo a random scatter with a magnitude defined by a frequency precision interval (e.g., 20 MHz), and the impact of the scatter on collision-free probability is assessed. As such, step 304 performs an initial yield pre-screening to determine which qubits require or would otherwise benefit from tuning via laser annealing operations. Based on such pre-screening, tuning plans are generated for each individual quantum computing-based device. As an example, a tuning plan may comprise a fixed multitude of frequency levels, and each qubit must reside on one of these levels. By appropriate assignment of each qubit to a frequency level, it is possible to avoid level degeneracies that may cause unwanted crosstalk and therefore low gate fidelity. Other examples of methods by which a tuning plan is generated may include a fixed frequency plan, or an optimization protocol by which each qubit may reside within a range of frequencies, whereby this range is subject to the frequency assignment of neighboring or next-nearest neighboring qubits. The methods for generating tuning plans here are not intended to be exhaustive, but rather serve as illustrative embodiments of methods by which tuning plans can be generated given a fixed lattice topology. In general, any tuning plan which mitigates frequency collisions would be considered acceptable.

Step 306 then ranks candidate quantum computing-based devices, or more particularly in some embodiments, their corresponding LASIQ tool computer based on the (pre-) screening results in step 304. For example, ranking may comprise listing which quantum computing-based devices should be laser annealed by their corresponding LASIQ tool computers from largest degree/level of tuning to lowest degree/level of tuning needed or otherwise desired. In some embodiments, candidate ranking can be as specific as ranking of qubits or Josephson junctions requiring tuning.

Step 308 then tunes the candidates. More particularly, based on the candidate ranking, laser annealing of the quantum computing-based devices is initiated by the LASIQ central computer and performed by their respective LASIQ tool computers based on the codebase and tuning parameters pushed thereto.

In step 310 post-laser annealing data (e.g., in-situ resistance measurements, LASIQ tool computer status information, etc.) is pulled from the LASIQ tool computers and synchronized at the LASIQ central computer. For example, as shown in step 312, pulled data can be synchronously stored in a database associated with the LASIQ central computer, e.g., cloud database 208, such that real-time visualization and analytics can be performed on the data. In step 314, real-time tracking of throughput, tuning metrics, and quantum computing-based device (e.g., also referred to herein as a processor or, more generally, as a chip) selection is performed. For example, throughput may be assessed by a variety of methods, including, but not limited to: the number of anneals as a function of tuned distance, or the total tuning time as a function of tuned distance, or the product of laser power and tuning time (total thermal load) as a function of tuned distance, the number of junctions tuned to completion after a given time, or any other method that provides a measure of tuning progression rate. Tuning metrics may include, but are not limited to: tuning precision, frequency collisions, or any other measure of the resulting quality of the tuning progression. It is to be understood that steps 312 and 314 are examples of operations that are executed on the pulled data (e.g., automated and/or initiated by a user) to determine results of the previous laser annealing iteration. For example, this may comprise quantifying and then evaluating how well the previous iteration did, presenting results to a user or another system, etc. In some embodiments, quantifying and evaluating may comprise determining whether a given frequency configuration and a yield target of a tuning plan have been achieved. The yield may be assessed using the previously mentioned statistical methodology, Monte Carlo methodology, or the like, and is not repeated here.

Post-LASIQ candidate selection is then performed in step 316 whereby the next iteration of laser annealing on candidate devices can be performed based on the visualization and analytics of step 312 and/or the tracking of step 314.

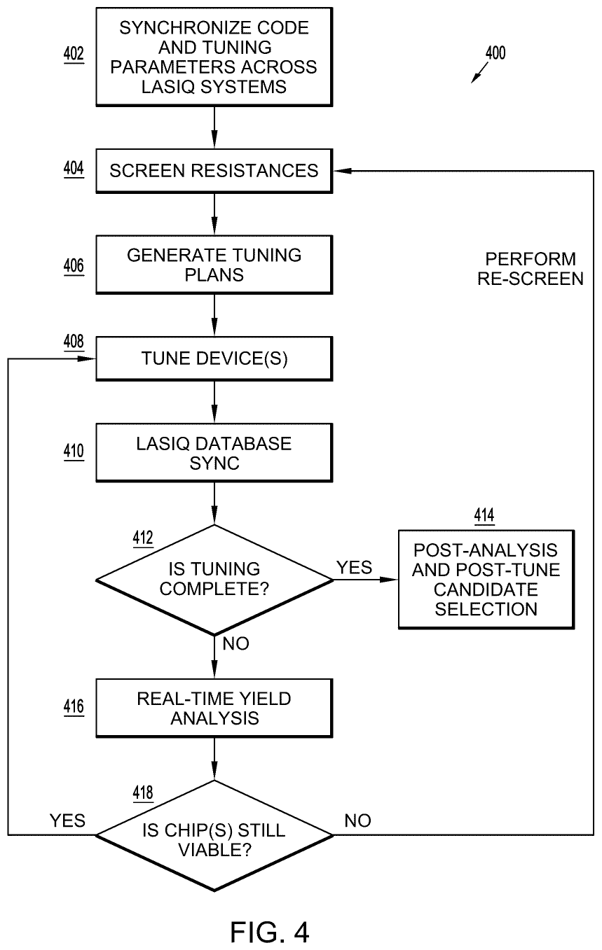

Turning now to FIG. 4, a non-linear process flow 400 for centralized laser annealing management is illustrated according to an illustrative embodiment. It is to be appreciated that non-linear process flow 400 is another non-limiting example of a computer system (e.g., LASIQ central computer 104 or 204) centrally managing laser annealing functionalities associated with a plurality of LASIQ tool computers (LASIQ tool computers 102 or 202). In some embodiments, non-linear process flow 400 can be used for real-time changes/correction to tuning plans. This is particularly useful for tuning modular devices, since multiple devices that will eventually be connected in a quantum computing application (i.e., modular devices) may not necessarily be tuned on the same LASIQ tool computer, however, the outcomes of tuning performed by a first LASIQ tool computer depend on tuning performed by a second LASIQ tool computer.

As shown, in step 402, a LASIQ central computer synchronizes code (e.g., codebase) and tuning parameters (as will be further explained below) across multiple LASIQ tool computers. In step 404, the LASIQ central computer screens resistances, i.e., determines current tunnel junction resistances of the Josephson junctions of the qubits on the quantum computing-based devices to determine whether or not they need to be laser annealed. In step 406, the LASIQ central computer generates a tuning plan for each quantum computing-based device to be laser annealed following the screening in step 404. The tuning plan is generated in the same or similar manner as described previously, using a fixed frequency pattern, a fixed frequency set of levels, optimization plans, or any methodology by which frequency collisions may be effectively mitigated.

Step 408 then tunes the devices. More particularly, based on the tuning plans generated in step 406, laser annealing of the quantum computing-based devices is initiated by the LASIQ central computer and performed by their respective LASIQ tool computers based on the codebase and tuning parameters pushed thereto.

In step 410, post-laser annealing data (e.g., in-situ resistance measurements, LASIQ tool computer status information, etc.) is pulled from the LASIQ tool computers and synchronized at the LASIQ central computer. For example, as explained above, pulled data can be synchronously stored in a database associated with the LASIQ central computer, e.g., cloud database 208. Step 412 then determines whether or not tuning is complete for a specific quantum computing-based device. Such a determination can be made by the LASIQ central computer, as explained above, using completion criteria determined via real-time tracking of throughput and tuning metrics for the specific device, as well as visualizations and analytics executed on the pulled data for the specific device. For example, a junction may be deemed ‘complete’ when the current junction resistance is measured to be within a certain threshold (e.g., 0.3%) of the target resistance. A specific quantum computing-based device (e.g., a singulated die intended as a distinct quantum processor chip) may be deemed complete when all junctions are tuned satisfactorily (e.g., within 0.3%) of target resistances, and statistical yield models indicate that the expected likelihood of collisions or probability of zero-collision yield lies below an acceptance threshold. This analysis may be supplemented by visualizations and analytics which may depict the overall progression of the laser annealing process to indicate, for example, a smooth and monotonic progression towards target resistances. Step 414 performs post-analysis and post-tune candidate selection if tuning is determined to be complete for the specific device, e.g., a next device in a modular device architecture scenario is selected for tuning.

If tuning is not complete on the specific device, then a real-time yield analysis is performed by the LASIQ central computer in step 416. Recall that yield refers to the probability of obtaining a collision-free qubit lattice following the previous laser annealing iteration. If the specific device (e.g., chip) is still viable (e.g., yield and/or some other viability criteria is acceptable), as determined by step 418, non-linear process flow 400 returns to step 408 to perform a next laser annealing (tuning) iteration on the specific device. If the specific device is no longer viable (e.g., yield and/or some other viability criteria is not acceptable), non-linear process flow 400 returns to step 404 to perform a resistance re-screening to then update tuning plans for laser annealing of other devices.

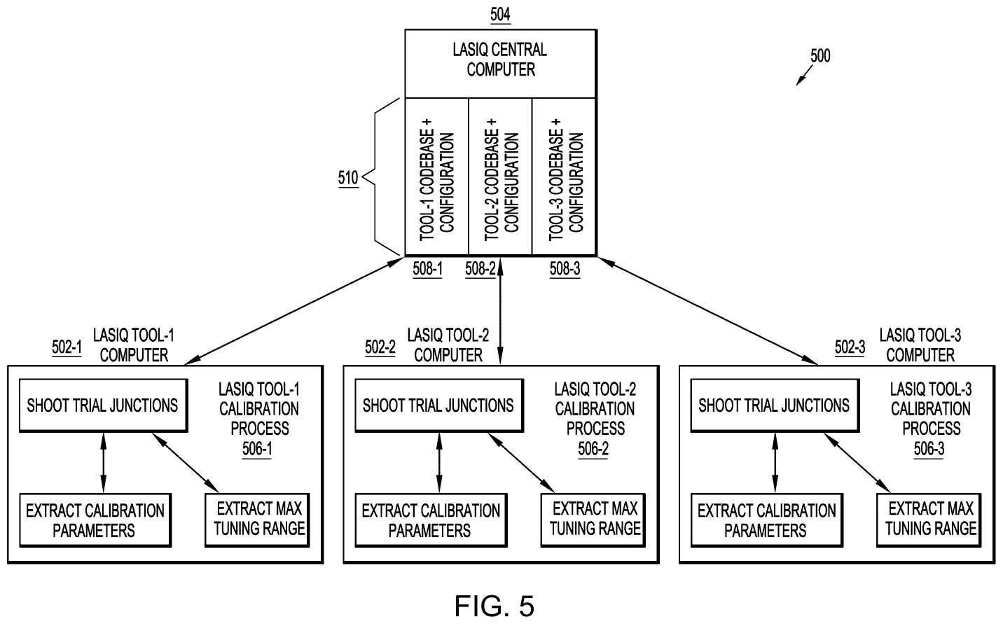

FIG. 5 illustrates a calibration process flow in a computer system architecture 500 with centralized laser annealing management functionalities according to an illustrative embodiment. More particularly, as shown, computer system architecture 500 comprises a plurality of LASIQ tool computers 502-1, 502-2, and 502-3 (i.e., LASIQ tool-1 computer, LASIQ tool-2 computer, and LASIQ tool-3 computer) operatively coupled to a LASIQ central computer 504. It is to be appreciated that, in some illustrative embodiments, LASIQ tool computers 502-1, 502-2, and 502-3 are configured with the same or similar functionalities as described herein with respect to LASIQ tool computers 102-1 through 102-N and/or LASIQ tool computers 202-1 through 202-N. Likewise, in some embodiments, LASIQ central computer 504 is configured with the same or similar functionalities as described herein with respect to LASIQ central computer 104 and/or LASIQ central computer 204. In a specific embodiment where the LASIQ central computer 504 is configured with the same functionality as the LASIQ central computer 104 and LASIQ central computer 204, the calibration and annealing may be performed on the same apparatus.

LASIQ central computer 504 is configured to coordinate various calibration parameters and tuning configurations based on individual calibration processes on each of LASIQ tool computers 502-1, 502-2, and 502-3. Any number of tool configurations and codebases can be incorporated. However, initially, LASIQ tool computers 502-1, 502-2, and 502-3 are calibrated as shown in FIG. 5.

More particularly, as shown, LASIQ tool computers 502-1, 502-2, and 502-3 have respective LASIQ tool calibration processes 506-1, 506-2, and 506-3 (i.e., LASIQ tool-1 calibration process, LASIQ tool-2 calibration process, and LASIQ tool-3 calibration process) executed thereby. For each of LASIQ tool calibration processes 506-1. 506-2, and 506-3, as illustratively shown, a pre-selected set of trial junctions are laser annealed (shoot trial junctions). From the trial junction annealing step, calibration parameters are extracted, as well as a maximum tuning rate. The trial junctions may be specific structures on the chip to be tuned, or from a sister chip that has undergone similar or identical processing, to identify tuning parameters to aid in the tuning success rate (e.g., by knowledge of tuning rate) and assist in generating tuning plans (e.g., by knowledge of maximum tuning range). This information is obtained by LASIQ central computer 504.

As further shown, LASIQ central computer 504 stores a tool codebase and configuration for each of LASIQ tool computers 502-1, 502-2, and 502-3, i.e., tool-1 codebase+configuration 508-1 (for LASIQ tool computer 502-1), tool-2 codebase+configuration 508-2 (for LASIQ tool computer 502-2), and tool-3 codebase+configuration 508-3 (for LASIQ tool computer 502-3). The tool codebases and configurations for each of LASIQ tool computers 502-1, 502-2, and 502-3 can be stored in a database 510 associated with LASIQ central computer 504.

In some embodiments, each of LASIQ tool calibration processes 506-1, 506-2, and 506-3 can perform laser annealing operations on Josephson junctions of representative hardware, using different combinations of laser anneal power and anneal time, to generate tuning calibration data (i.e., extract calibration parameters). The tuning calibration data can be obtained by performing a calibration process on representative hardware which, in some embodiments, can be dummy Josephson junctions that reside on the same quantum computing-based device to be tuned, and in other embodiments, can be Josephson junctions of qubits that are formed on a “sister” device from the same fabrication process. The tuning calibration data is analyzed using statistical methods to fit the tuning calibration data to tuning curves, wherein the tuning curves are utilized to determine tuning rates and maximum tuning ranges for Josephson junctions under different laser anneal powers and anneal times. The tuning curves can be utilized by LASIQ central computer 504 to select a target combination of anneal power and anneal time, as desired, to obtain a target tuning rate and maximum tuning range for laser annealing Josephson junctions of the given quantum computing-based device, post fabrication. In some embodiments, the tuning curves are used to predict an initial laser anneal operation (initial shot) for tuning a given Josephson junction to a certain target (e.g., 50% to target) on a first shot. The calibration process ensures a smooth and rapid approach to a target tuning resistance for a given Josephson junction, while mitigating risk of both undershooting and overshooting the tuning.

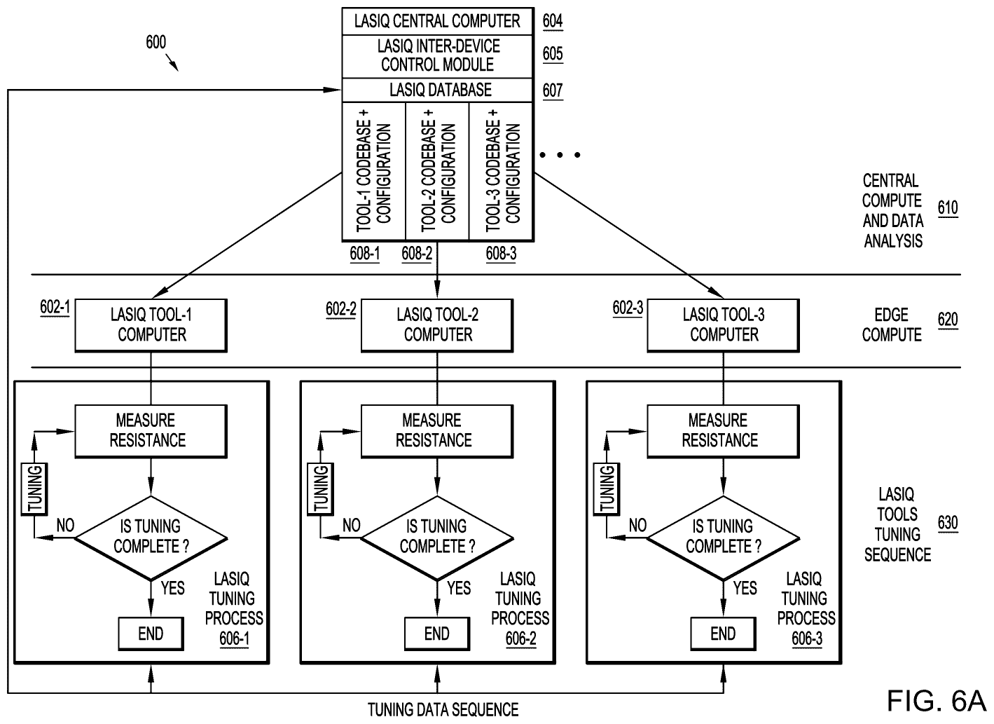

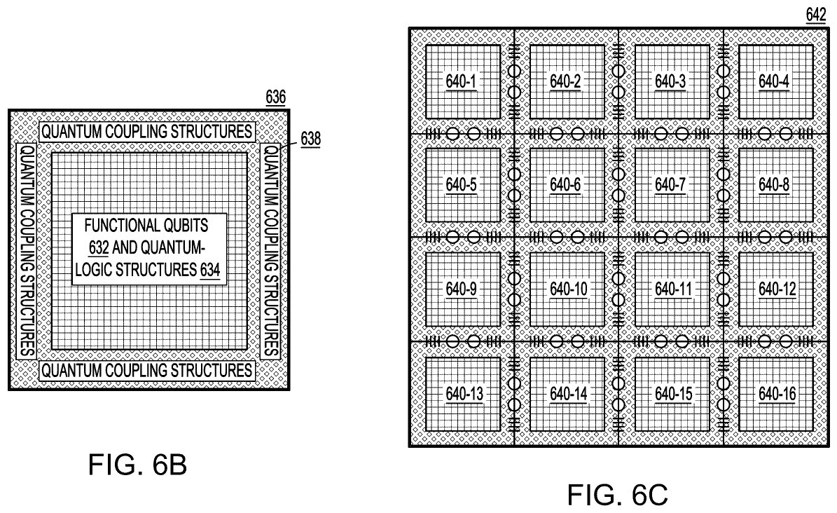

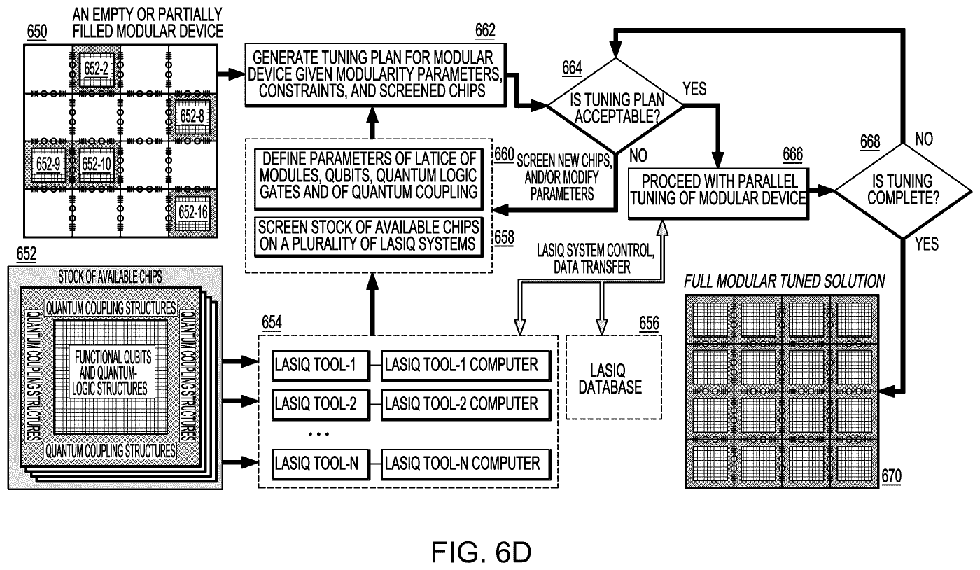

FIG. 6A illustrates a tuning process flow in a computer system architecture 600 with centralized laser annealing management functionalities according to an illustrative embodiment. More particularly, as shown, computer system architecture 600 comprises a plurality of LASIQ tool computers 602-1, 602-2, and 602-3 (i.e., LASIQ tool-1 computer, LASIQ tool-2 computer, and LASIQ tool-3 computer) operatively coupled to a LASIQ central computer 604. It is to be appreciated that, in some illustrative embodiments, LASIQ tool computers 602-1, 602-2, and 602-3 are configured with the same or similar functionalities as described herein with respect to LASIQ tool computers 502-1, 502-2, and 502-3. Likewise, in some embodiments, LASIQ central computer 604 is configured with the same or similar functionalities as described herein with respect to LASIQ central computer 504.

LASIQ central computer 604 is configured to perform LASIQ tool initialization of source code and tuning configuration and parameters. More particularly, based on calibrations on each individual system (e.g., the calibration process flow in FIG. 5), LASIQ central computer 604 coordinates the data and pushes updated source code and configuration files to each of LASIQ tool computers 602-1, 602-2, and 602-3 for optimized tuning.

More particularly, as shown, LASIQ tool computers 602-1, 602-2, and 602-3 have respective LASIQ tuning processes 606-1, 606-2, and 606-3 executed thereby. For each of LASIQ tuning processes 606-1, 606-2, and 606-3, as illustratively shown, junction resistances are measured on the corresponding device after each laser annealing iteration, and if tuning is complete (e.g., junction resistance is at required/desired value, for example, within 0.3% of the target resistance), the tuning process ends, otherwise it continues with a next tuning iteration.

Note also that, as shown, LASIQ central computer 604 has a LASIQ inter-device control module 605 which is responsible for the coordination of a plurality of edge compute LASIQ tool computers 602-1, 602-2, and 602-3 for the purpose of tuning a plurality of quantum devices that may be part of a larger interconnected modular quantum device. As previously described, modular device or modular quantum device refers to a group of quantum devices that are interconnected at the boundaries, whereby the quantum computational capacity as a whole is greater than the quantum computational capacity of any of the constituent quantum devices. The LASIQ central computer 604, and thus LASIQ inter-device control module 605, is in direct communication with a LASIQ database 607 associated therewith which stores a tool codebase and configuration for each of LASIQ tool computers 602-1, 602-2, and 602-3, i.e., tool-1 codebase+configuration 608-1 (for LASIQ tool computer 602-1), tool-2 codebase+configuration 608-2 (for LASIQ tool computer 602-2), and tool-3 codebase+configuration 608-3 (for LASIQ tool computer 602-3). The LASIQ database 607 is responsible for the storage of annealing parameters, progression, junction process information, and the like, such that the identification, process history, and annealing history can be reconstructed for each individual junction on any quantum device that is subjected to the LASIQ annealing process in tier 630 by the LASIQ annealing tools.

In some embodiments of computer system architecture 600, LASIQ central computer 604, LASIQ inter-device control module 605, and LASIQ database 607 can be implemented at a central compute and data analysis tier 610 (e.g., public, private or hybrid cloud platform), while LASIQ tool computers 602-1, 602-2, and 602-3 are implemented at an edge compute tier 620. Then, at a LASIQ tools tuning sequence tier 630, the actual tuning occurs (e.g., locally where the quantum computing-based devices are situated). However, each LASIQ tool computer (602-1, 602-2, and 602-3) and the quantum computing-based device on which it is implementing laser annealing/tuning are typically co-located, although that is not necessarily required in alternative embodiments. A tuning data sequence is associated with each of the LASIQ tuning processes 606-1, 606-2, and 606-3. The data for each junction is sent to the LASIQ database 607, which contains all relevant information for each tuned quantum element, such that its identity, process details, tuning history, and the like, may be reconstructed and analyzed by the inter-device control module 605 and LASIQ central computer 604. Using this tuning data, it may be possible to perform in-situ and real-time revisions of the frequency tuning plans such that the functional yield of the final device, either modular or non-modular, is optimized.

FIG. 6B shows a schematic of the architecture of a singulated quantum device which is intended to be a constituent device as part of a modular quantum device. An example of such a complete modular device is schematically shown in FIG. 6C. This depicted modular quantum device 642 is comprised of a 4×4 grid of interconnected singulated dies in a square array, i.e., containing a total of 16 devices, with individual processors 640-1, 640-2, 640-3, . . . , 640-16. This square array is used as an exemplary embodiment of a modular quantum device, but other connectivity geometries, including a line, a ring, or the like, may also be used. At the boundaries between adjacent chips, the modular manifold provides both direct microwave links as well as microwave resonators. Although these two links are depicted in the figure, it may be generally understood that the links are not limited to the quantum coupling structures depicted here, and generally any other suitable link to mediate quantum coupling is acceptable. In one or more embodiments, the manifold is achieved by microwave coupling and links between cryogenic refrigerators. In general, the problem of tuning a modular device is given by the need to mitigate both frequency crowding internal to the singulated processor devices, as well as externally between adjacently coupled quantum devices. In general, the individual chips that will be part of a modular device will not be tuned on the same LASIQ tool, and care should therefore be taken to ensure the data is appropriately synchronized by the LASIQ inter-device control module (605 in FIG. 6A) to ensure the devices being tuned remain a viable member of the whole.

Referring back to FIG. 6B, in general, each singulated quantum device 636 or chip will be comprised of some combination of functional qubits 632, quantum-logic structures 634, quantum coupling structures 638, and the like. The functional qubits and other quantum-logic structures store, manipulate or transfer quantum information and quantum logic within the singulated device, while the quantum coupling structures enable such actions from one module to another. More specifically, the transfer of quantum information and quantum logic across the boundary of adjacent chips is mediated by the modular device manifold, which may contain microwave resonators, direct microwave links, and the like.

Further, in FIG. 6B, the functional qubits and quantum-logic structures are situated in the interior of the chip and the quantum coupling structures are placed along the chip edges, although this is intended as an exemplary embodiment of a singulated device and other arrangements or designs may be implemented in practice. In one or more illustrative embodiments, all structures are made of superconducting materials on a dielectric substrate and all structures contain Josephson junctions whose tunnel-barrier is susceptible to tuning by laser annealing. The use of a laser annealing tool (of which LASIQ is a special case) may therefore be utilized to tune all elements on the singulated chip, which in general includes quantum coupling elements. Structures may include qubits of various kinds, or SQUIDs, or single Josephson junctions, or other combinations of Josephson junctions, capacitors and inductors. They may be galvanically, inductively, or capacitively linked with neighboring structures on-chip. The functional structures may contain Josephson junctions that are of different design or construction as compared to the Josephson junctions in the quantum coupling structures. Given the wide variety of quantum elements comprising Josephson junctions, it is necessary to perform calibrations to determine their response to laser-power and exposure time. These separate calibrations determine the tuning range and tuning rates specific to the functional structures and to the quantum coupling structures. Such calibration may, for example, be carried out in the illustrative embodiment depicted in FIG. 5.

FIG. 6D depicts a process by which a modular device may be tuned on a plurality of LASIQ systems. An initial empty modular manifold, or partially filled modular manifold 650 may be the initial condition of the modular quantum device. The modular device 650 is shown with partially filled sites 652-2, 652-8, 652-9, 652-10, and 652-16 which are individual chips that have been entered into the modular device, or part of an already pre-existing modular device. In particular, sites 652-9 and 652-10 are already connected with suitable boundary conditions. The remaining lattice sites are shown as empty, and are to be populated by tuning appropriate devices compatible with the existing pre-filled modular quantum device. Such a device 650 may arise during the process of tuning, where for example, a tuning algorithm that is implemented that populates lattice sites in asynchronous order. In another example, a pre-filled device 650 may arise when an existing modular device requires replacement of its individual constituent devices. In parallel, a stock of available chips and/or devices 652 may be present as part of a wafer, or a set of individual singulated dies.

In general, the stock of available chips will not be present on a single LASIQ apparatus, but will occur across a plurality of LASIQ systems 654 (shown as LASIQ Tool-1, LASIQ Tool-2, . . . , LASIQ Tool-N) that are controlled by a plurality of LASIQ computer systems (shown as LASIQ Tool-1 Computer, LASIQ Tool-2 Computer, . . . , LASIQ Tool-N Computer). The stock of available chips may be measured and screened for appropriate use as part of a modular device, based on requirements such as predicted frequency range, of functional qubits, quantum-logic structures, quantum coupling structures and its compatibility with coupling elements on the modular manifold. These requirements may be determined in conjunction with 660, where the parameters of the lattice of modules, and that of the individual device is selected.

For example, one choice of parameters may include the desired boundary conditions of the coupling elements on the manifold between adjacent chips. Individual chips must then be selected on the basis of being able to satisfy the boundary frequency requirements of its quantum coupling structures. A tuning plan is then generated in step 662. In general, a solution for a modular device is more challenging than the solution for a singulated device, given that not only must the individual device achieve a yield target, but it must do so given the presence of boundary constraints as defined by its coupling to an adjacent neighboring device, via a coupling manifold comprised of microwave links, resonators, and the like. Various methods may be implemented to simplify the process of reaching such a solution, and a tuning plan in step 662 is generated using such methods. For example, the boundary conditions relating to the coupling manifold may be fixed, leading to the selection of only those singulated devices that are able to satisfy boundary conditions for each remaining empty modular site in partially filled modular manifold 650. Although a fixed boundary condition is used here as an example, any suitable variety of tuning plans may be implemented, all of which will require the active feedback amongst a plurality of LASIQ computer systems and apparatuses as shown in FIG. 6A.

In step 662, the tuning plan may be generated on the central LASIQ computer (604 in FIG. 6A). After the tuning plan is generated, the plan is assessed in step 664, by determining whether the modular device tuning plan satisfies frequency constraints and yield criteria. For example, the number of frequency collisions may be assessed, and statistical analysis may be performed to determine the expected number of frequency collisions that will be obtained both within and across each chip of the modular device. Additionally, a zero-collision yield may be determined, which provides a direct measure of the probability that modular device may be usable. If the tuning plan as assessed in such a manner is not acceptable, the system returns to steps 658 and 660, where a new stock of chips may be screened based on updated parameters of the functional qubits, quantum logic structure and coupling structures. If the tuning plan is acceptable, tuning proceeds in parallel in step 666 amongst a plurality of LASIQ tools and as controlled by a plurality of LASIQ tool computers of block 654. It is to be appreciated that, in some illustrative embodiments, LASIQ tool computers 654 are configured with the same or similar functionalities as described herein with respect to LASIQ tool computers 102-1 through 102-N and/or LASIQ tool computers 202-1 through 202-N and/or LASIQ tool computers depicted in the edge compute layer 620. As the tuning progresses, the tuning sequence and junction information is provided to a LASIQ database 656, such that the entire tuning history of each Josephson junction may be individually tracked. In some illustrative embodiments, LASIQ database 656 is configured with the same or similar functionalities as described herein with respect to cloud database 208 and/or LASIQ database sync 410 and/or LASIQ database 607. If the tuning is deemed complete in step 668, the full modular tuned solution 670 is successfully achieved. Otherwise, the tuning returns to step 664, the existing tuning plan is assessed, and the tuning either proceeds (step 666) or the tuning plan is modified (steps 658, 660, and 662) as desired. The methods implemented here, namely a combination of one or more of steps 658 to 668, is performed by the inter-device control module 605, as previously described and depicted in FIG. 6A.

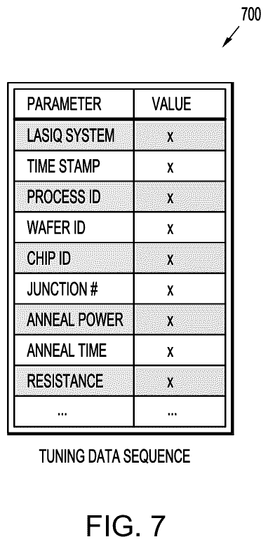

By way of example only, FIG. 7 illustrates a tuning data sequence 700 showing a plurality of tuning parameters. As shown, tuning parameters can include, but are not limited to, a LASIQ system (tool) identifier, a time stamp (i.e., time of laser anneal), a process identifier (ID), a wafer ID, a chip ID, a junction number (#), an anneal power level, an anneal time (i.e., anneal duration), and a resistance (measured at junction).

Thus, as per the example of tuning data sequence 700, it is to be understood that each junction has a simple output set of values that get stored at a LASIQ database (e.g., LASIQ database 607) in real-time. The LASIQ database is a running database of all junctions tuned on all different LASIQ tools. Each junction has a unique number, is linked to a chip ID, and has associated anneal parameters (e.g., anneal power, anneal time) and electrical characterization outcomes (e.g., measured junction resistance) such that every qubit junction is uniquely traceable to a chip and wafer corresponding to a fabrication process. The various tuning parameter IDs and numbers for a given LASIQ tool computer 602 enable LASIQ central computer 604 to aggregate and synchronize the tuning data sequences across different LASIQ tool computers 602.

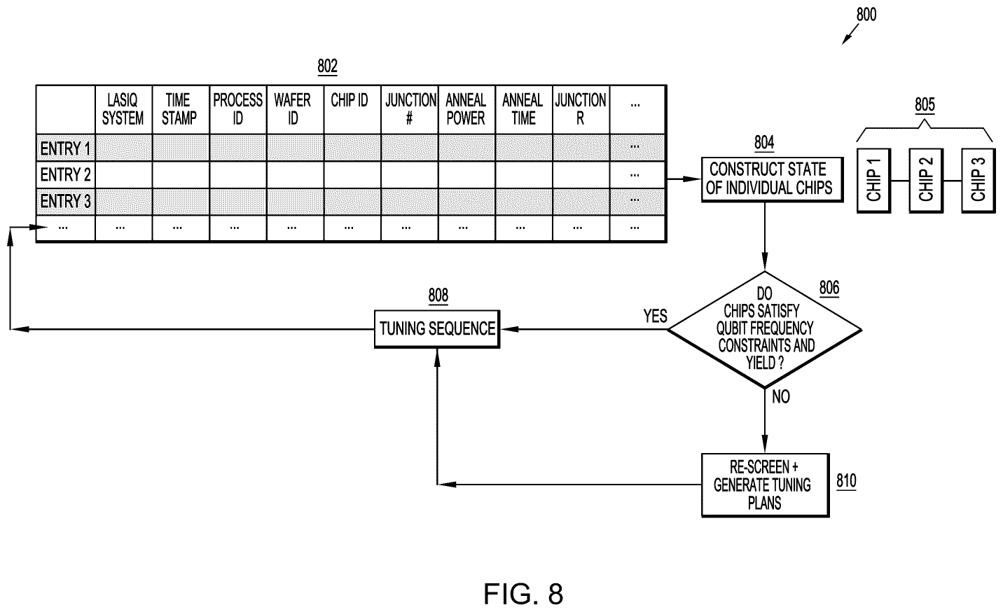

FIG. 8 illustrates an exemplary database process flow 800 associated with a computer system configured with centralized laser annealing management functionalities according to an illustrative embodiment. As shown, database 802 comprises columns with tuning parameter headings for a LASIQ system (tool) identifier, a time stamp, a process ID, a wafer ID, a chip ID, a junction #, an anneal power level, an anneal time, and a measured junction resistance R_{J}. The rows in database 802 represent each laser annealing/tuning iteration (e.g., entry 1, entry 2, entry 3, . . . ) managed by the LASIQ central computer. Advantageously, in accordance with database 802, all qubit tuning data is stored and each qubit junction can be linked back to a chip, a wafer, and a junction process. Note that, by way of example only, database 802 can be implemented as part of LASIQ database 607 associated with LASIQ central computer 604 in FIG. 6. In an exemplary embodiment, database 802 is configured with entries that directly pertain to tuning data sequence 700, which is a consequence of LASIQ tools tuning sequence 630 and is pulled from the LASIQ tool edge compute layer 620.

Step 804 constructs the state of individual chips, e.g., chip 1, chip 2, and chip 3, collectively referred to as chips 805. These chips may, for example, be three uncoupled devices, individually to be used in separate quantum processors, or may be used as part of a single modular device, with a defined interconnectivity between the three chips. In the case where the three processors comprise one modular device, the LASIQ central computer 604 will be responsible for ensuring synchronization between the various LASIQ tool computers 601-1, 602-2, and 602-3 to ensure that tuning progresses while appropriately accounting for the boundary collisions imposed by the connectivity and ordering constraints amongst the three processors. More particularly, following a laser annealing/tuning iteration, the LASIQ tool computer associated with each chip collects the tuning data sequence reflecting the results of the tuning iteration and provides the data to the LASIQ central computer. Based on the received tuning data sequences, in step 806, the LASIQ central computer then determines whether each of the chips satisfy qubit frequency constraints and yield criteria. If so, each tuning data sequence 808 is written to database 802 as a new entry as shown. If not, then in step 810, a re-screening is performed and new tuning plans are generated, as explained in detail herein.

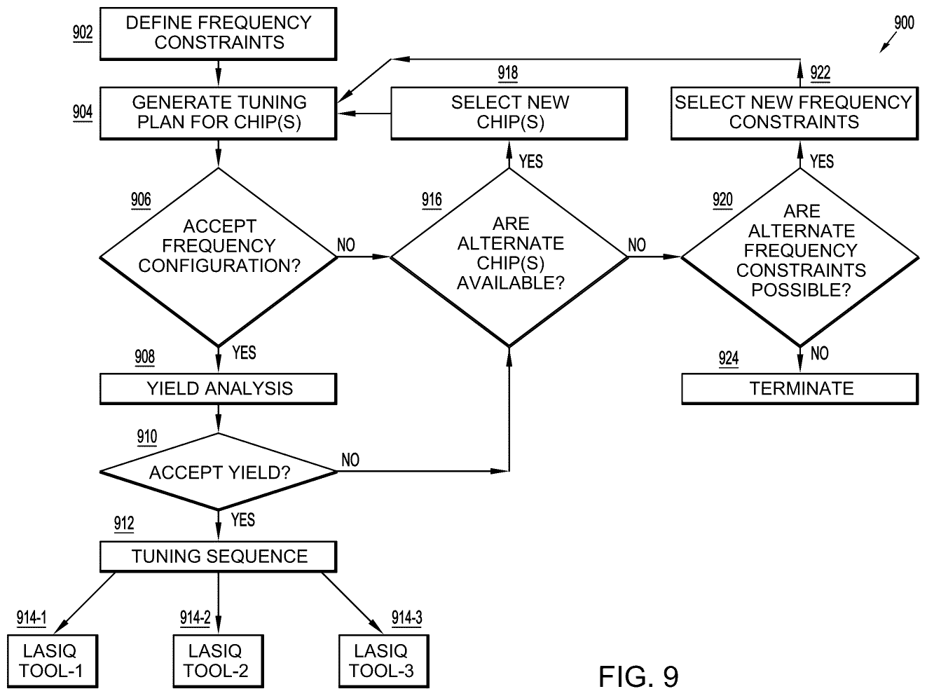

FIG. 9 illustrates a process flow 900 for determining completion of a tuning process in a computer system architecture with centralized laser annealing management functionalities according to an illustrative embodiment. More particularly, process flow 900 may be considered an illustrative implementation of step 806 performed by the LASIQ central computer in FIG. 8.

Step 902 defines frequency constraints, and a tuning plan for one or more chips is generated in step 904. In one example, the tuning plan comprises a fixed frequency pattern as the frequency configuration. Step 906 determines whether or not the frequency configuration is accepted. If yes, then in step 908, a yield analysis is performed as explained herein. If the yield is accepted in step 910, then a tuning sequence 912 is generated and pushed to each LASIQ tool computer 914-1, 914-2, and 914-3 for implementation. If the frequency configuration (step 906) or the yield (step 910) is not accepted, then step 916 determines whether or not an alternate chip(s) is available as the currently considered chip(s) is not viable. If yes, then a new chip(s) is selected in step 918 and a tuning plan for the new chip(s) is generated in step 904 and the subsequent steps of process flow 900 are re-executed. If no alternate chip(s) is available (step 916), then step 920 considers whether or not alternate frequency constraints are possible. If yes, then new frequency constraints are selected in step 922 and a tuning plan with the new frequency constraints for the existing chip(s) is generated in step 904 and the subsequent steps of process flow 900 are re-executed. If no alternate frequency constraints are possible (step 920), then process flow 900 terminates at step 924. It is to be appreciated that, in some illustrative embodiments, the process flow 900 may be considered functionally the same or similar to steps 658 to 666 involved in the tuning of a modular device, and may be considered as an illustrative implementation of real-time and in-situ feedback during the tuning of a modular device as described in the process depicted in FIG. 6D.

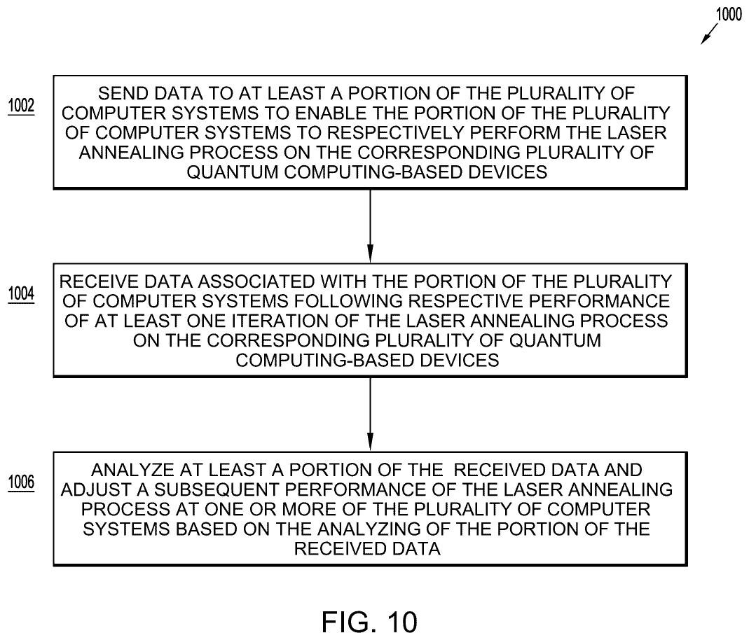

FIG. 10 illustrates a methodology 1000 for centralized laser annealing management according to an illustrative embodiment. As shown, step 1002 sends data to at least a portion of the plurality of computer systems to enable the portion of the plurality of computer systems to respectively perform the laser annealing process on the corresponding plurality of quantum computing-based devices. Step 1004 receives data associated with the portion of the plurality of computer systems following respective performance of at least one iteration of the laser annealing process on the corresponding plurality of quantum computing-based devices. Step 1006 analyzes at least a portion of the received data and adjusts a subsequent performance of the laser annealing process at one or more of the plurality of computer systems based on the analyzing of the portion of the received data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

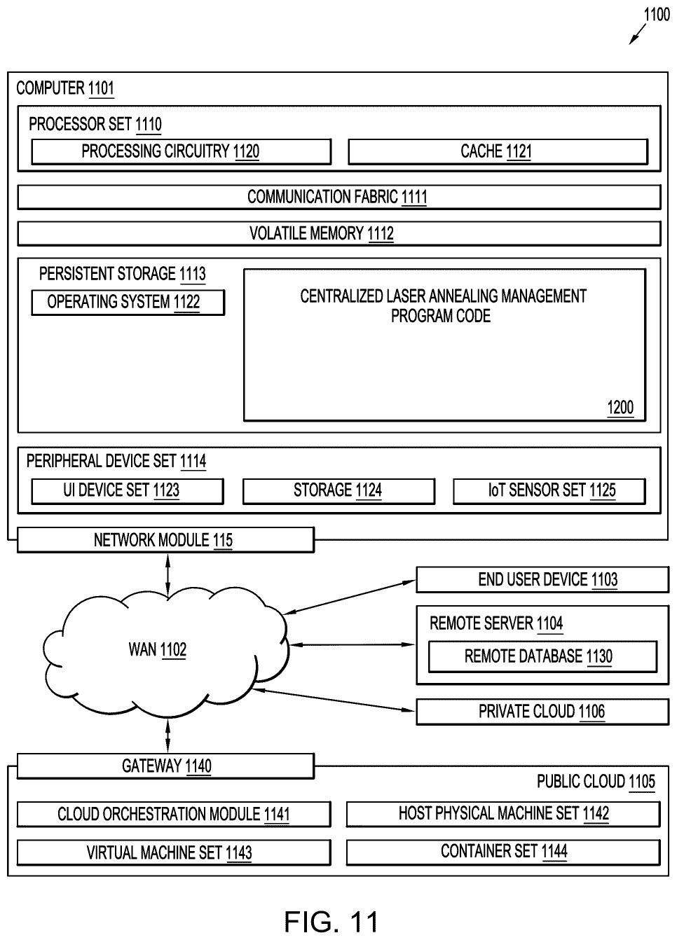

Computing environment 1100 of FIG. 11 contains an example of an environment for the execution of at least some of the computer code (block 1200) involved in executing centralized laser annealing management functionalities (e.g., described herein in the context of FIGS. 1-10). In addition to block 1200, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

Computer 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

Processor set 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

Communication fabric 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

Persistent storage 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

Peripheral device set 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

Network module 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

Remote server 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

Public cloud 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container. a feature which is known as containerization.

Private cloud 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

As explained herein, embodiments are directed to centrally managing a plurality of computer systems configured to respectively perform a laser annealing process on a plurality of quantum computing-based devices configured to function as a modular quantum device as described herein.

In one embodiment, an apparatus comprises at least one processor and at least one memory storing program code that, when executed by the at least one processor, cause the apparatus to centrally manage a plurality of computer systems configured to respectively perform a laser annealing process on a plurality of quantum computing-based devices.

For example, centrally managing the plurality of computer systems may further comprise sending data to at least a portion of the plurality of computer systems to enable the portion of the plurality of computer systems to respectively perform the laser annealing process on the corresponding plurality of quantum computing-based devices.

For example, sending the data to the portion of the plurality of computer systems may be performed in a synchronized manner to enable coordinated performance of the laser annealing process across the portion of the plurality of computer systems.

For example, the data sent to each of the portion of the plurality of computer systems may comprise program code and parameters configured to control the laser annealing process performed by each of the portion of the plurality of computer systems.

For example, centrally managing the plurality of computer systems may further comprise receiving data associated with the portion of the plurality of computer systems following respective performance of at least one iteration of the laser annealing process on the corresponding plurality of quantum computing-based devices.

For example, the data associated with the portion of the plurality of computer systems following respective performance of at least one iteration of the laser annealing process may be received from a database that is at least one of local to the apparatus and remote from the apparatus.

For example, centrally managing the plurality of computer systems may further comprise analyzing at least a portion of the received data and adjusting a subsequent performance of the laser annealing process at one or more of the plurality of computer systems based on the analyzing of the portion of the received data.

For example, analyzing at least a portion of the received data may further comprise performing a yield analysis to assess yield results of a previous performance of the laser annealing process at the portion of the plurality of computer systems.

For example, adjusting a subsequent performance of the laser annealing process at one or more of the plurality of computer systems may further comprise modifying one or more aspects of the laser annealing process for one or more of the plurality of computer systems.

For example, modifying the one or more aspects of the laser annealing process may further comprise changing one or more of a yield target value, a frequency configuration, and the one or more quantum computing-based devices corresponding to the one or more of the plurality of computer systems.

For example, centrally managing the plurality of computer systems may further comprise causing calibration of the plurality of computer systems prior to respective performance of the laser annealing process on the plurality of quantum computing-based devices.

For example, centrally managing the plurality of computer systems may further comprise receiving calibration data from the plurality of computer systems following calibration.

For example, centrally managing the plurality of computer systems may further comprise tracking in a database one or more qubit junctions in each of the plurality of quantum computing-based devices with respect to a chip identifier, a wafer identifier, and a laser annealing process identifier.

In another embodiment, a method comprises centrally managing a plurality of computer systems configured to respectively perform a laser annealing process on a plurality of quantum computing-based devices.

For example, the laser annealing process may comprise a process for laser annealing of stochastically impaired qubits (LASIQ).

For example, centrally managing the plurality of computer systems may further comprise sending data to at least a portion of the plurality of computer systems to enable the portion of the plurality of computer systems to respectively perform the laser annealing process on the corresponding plurality of quantum computing-based devices.

For example, centrally managing the plurality of computer systems may further comprise receiving data associated with the portion of the plurality of computer systems following respective performance of at least one iteration of the laser annealing process on the corresponding plurality of quantum computing-based devices.

For example, centrally managing the plurality of computer systems may further comprise analyzing at least a portion of the received data and adjusting a subsequent performance of the laser annealing process at one or more of the plurality of computer systems based on the analyzing of the portion of the received data.

In another illustrative embodiment, a control module may be implemented to coordinate a plurality of computer systems to select, coordinate laser annealing processes, and monitor yield of devices corresponding to the one or more of the plurality of computer systems.

For example, in some illustrative embodiments, a control module may be implemented in the coordinated screening of a plurality of quantum device candidates which may be intended as part of a larger interconnected modular device, using at least a portion of the received data from a plurality of computer systems.

For example, in some illustrative embodiments, a control module may be implemented in the coordinated laser annealing of a plurality of screened quantum device candidates which may be intended as part of a larger interconnected modular device, using at least a portion of the received data from a plurality of computer systems.

For example, in some illustrative embodiments, a control module may be implemented in the real-time monitoring of device yield amongst a plurality of quantum device candidates subjected to the laser anneal process, which may be intended as part of a larger interconnected modular device, using at least a portion of the received data from a plurality of computer systems.

For example, in some illustrative embodiments, a control module may be implemented modify or alter, in real-time, the tuning parameters and/or tuning plan of a plurality of quantum device candidates subjected to the laser anneal process, which may be intended as part of a larger interconnected modular device, using at least a portion of the received data from a plurality of computer systems.

In yet another embodiment, a computer program product for performing laser annealing comprises one or more computer readable storage media, and program instructions collectively stored on the one or more computer readable storage media, the program instructions comprising program instructions to centrally manage a plurality of computer systems configured to respectively perform a laser annealing process on a plurality of quantum computing-based devices.

In a further embodiment, a computer system architecture comprises a plurality of first computer systems, wherein the plurality of first computer systems are configured to respectively perform a laser annealing process on a plurality of quantum computing-based devices, and a second computer system operatively coupled to the plurality of first computer systems, wherein the second computer system is configured to centrally manage the laser annealing process respectively performed by the plurality of first computer systems on the plurality of quantum computing-based devices.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus, comprising:
at least one processor; and
at least one memory storing program code that, when executed by the at least one processor, cause the apparatus to centrally manage a plurality of computer systems configured to respectively perform a laser annealing process on a plurality of quantum computing-based devices configured to function as a modular quantum device.

2. The apparatus of claim 1, wherein centrally managing the plurality of computer systems further comprises generating a tuning plan for the modular quantum device.

3. The apparatus of claim 2, wherein the tuning plan for the modular quantum device is based on at least one of: one or more modularity parameters, one or more modularity constraints, and one or more screening criteria.

4. The apparatus of claim 2, wherein centrally managing the plurality of computer systems further comprises sending data to the plurality of computer systems to enable the computer systems to respectively perform the laser annealing process on the corresponding plurality of quantum computing-based devices in accordance with the tuning plan for the modular quantum device.

5. The apparatus of claim 4, wherein sending the data to the portion of the plurality of computer systems is performed in a synchronized manner to enable coordinated performance of the laser annealing process across the plurality of computer systems.

6. The apparatus of claim 4, wherein centrally managing the plurality of computer systems further comprises receiving data associated with the plurality of computer systems following respective performance of at least one iteration of the laser annealing process on the corresponding plurality of quantum computing-based devices configured to function as the modular quantum device.

7. The apparatus of claim 6, wherein at least a portion of the data sent to, and received from, the plurality of computer systems is stored in a database.

8. The apparatus of claim 7, wherein the database is at least one of local to the apparatus and remote from the apparatus.

9. The apparatus of claim 5, wherein centrally managing the plurality of computer systems further comprises analyzing at least a portion of the received data and adjusting a subsequent performance of the laser annealing process at one or more of the plurality of computer systems based on the analyzing of the portion of the received data.

10. The apparatus of claim 9, wherein the analyzing at least a portion of the received data further comprises performing a yield analysis to assess yield results of a previous performance of the laser annealing process at the portion of the plurality of computer systems.

11. The apparatus of claim 9, wherein the adjusting a subsequent performance of the laser annealing process at one or more of the plurality of computer systems further comprises modifying one or more aspects of the tuning plan for one or more of the plurality of computer systems.

12. The apparatus of claim 11, wherein modifying the one or more aspects of the laser annealing process further comprises changing one or more of a yield target value, a frequency configuration, and the one or more quantum computing-based devices corresponding to the one or more of the plurality of computer systems.

13. The apparatus of claim 1, wherein centrally managing the plurality of computer systems further comprises causing calibration of the plurality of computer systems prior to respective performance of the laser annealing process on the plurality of quantum computing-based devices.

14. The apparatus of claim 13, wherein centrally managing the plurality of computer systems further comprises receiving calibration data from the plurality of computer systems following calibration.

15. The apparatus of claim 1, wherein centrally managing the plurality of computer systems further comprises tracking in a database one or more qubit junctions in each of the plurality of quantum computing-based devices with respect to a chip identifier, a wafer identifier, and a laser annealing process identifier.

16. The apparatus of claim 1, wherein at least part of centrally managing the plurality of computer systems is implemented via an inter-device control module.

17. A method, comprising:
centrally managing a plurality of computer systems configured to respectively perform a laser annealing process on a plurality of quantum computing-based devices configured to function as a modular quantum device.

18. The method of claim 17, wherein centrally managing the plurality of computer systems further comprises generating a tuning plan for the modular quantum device.

19. The apparatus of claim 18, wherein the tuning plan for the modular quantum device is based on at least one of: one or more modularity parameters, one or more modularity constraints, and one or more screening criteria.

20. A computer system architecture, comprising:
a plurality of first computer systems, wherein the plurality of first computer systems is configured to respectively perform a laser annealing process on a plurality of quantum computing-based devices configured to function as a modular quantum device; and
a second computer system operatively coupled to the plurality of first computer systems, wherein the second computer system is configured to centrally manage the laser annealing process respectively performed by the plurality of first computer systems on the plurality of quantum computing-based devices configured to function as the modular quantum device.
